(19) United States
(12) Patent Application Publication
(10) Pub. No.: US 2006/0223548 A1
(43) Pub. Date: Oct. 5, 2006

(54) Method for sending urgent messages in a mobile communication device

(75) Inventor: Hau-Ling Tse, Taipei (TW)

Correspondence Address: BRUCE H. TROXELL, SUITE 1404, 5205 LEESBURG PIKE, FALLS CHURCH, VA, 22041, US

(73) Assignee: Inventec Appliances Corp.

(21) Appl. No.: 11/390,261

(22) Filed: Mar. 28, 2006

(30) Foreign Application Priority Data
Mar. 29, 2005 (TW) 94109885

(51) Int. Cl. H04Q 7/20

(52) U.S. Cl. 455/456.1; 455/433

(57) ABSTRACT

A method of sending urgent messages for a mobile communication device is disclosed in this invention, which comprises at least the flowing steps: setting at least two predetermined keys on the first mobile communication device, pressing the two keys essentially simultaneously for a predetermined duration, acquiring a base station identity code, obtaining location information of the first mobile communication device according to the base station identity code and a preset correspondence table in the first mobile communication device, and sending a message containing said location information to at least one second mobile communication device. When a user of the second mobile communication device receives the predetermined message, the user can deal properly with the situation through the information of the predetermined messages.

### FIELD OF THE INVENTION

The present invention relates to a method of sending urgent messages in a mobile communication device, especially to a message comprising location information of the mobile communication device.

### BACKGROUND OF THE INVENTION

Portable mobile communication device such as mobile phones already become common and indispensable tools around people. Due to different user age, different additional functions are developed to meet the need of users. For instance, children or women may need a function about urgent calling while they are alone.

Generally, urgent calling is a common function of general mobile phones for urgent situation like getting lost in remote mountains or being besieged in unfamiliar places. Please refer to FIG. 1, which is a flow chart of urgent calling for help in a general communication phone. The procedure in FIG. 1 comprises:
Step11 (S11): dialing an urgent number; different communication systems have different numbers, for instance, the urgent numbers for the Global system for mobile communication (GSM) are 112 and 855;
Step12 (S12): after the dialing, the mobile communication device sending out an SOS message;
Step13 (S13): the communication base station receiving the SOS message and transmitting it to the police station or other related organizations;
Step14 (S14): the communication base station positioning the message source in the meantime with the step14 through tracing the electromagnetic wave from the first mobile communication device;
Step15 (S15): proceeding the emergency rescue.

The procedure mentioned above is well known, but dialing an urgent number for helping has a disadvantage that the user may forget the number while he/she is in a flurry, and thus the method mentioned above is of no help.

In some urgent situation such as being abducted, the user may choose another way to send a message for calling help. Please refer to FIG. 2, which shows a flow chart of sending messages in urgent situation. The procedure shown in FIG. 2 comprises following steps.
Step21 (S21): setting at least one communication number, herein the communication number corresponds to a second mobile communication device;
Step22 (S22): inserting or editing the message, wherein the message could be edited in advance for help such as “I am kidnapped” or “Help me, call the police for me”, or the contents that where the user is;
Step23 (S23): the user pressing the enter bottom to deliver the message;
Step24 (S24): then the predetermined second mobile communication device receiving the message for calling help.

Although the method mentioned above is simple, while the user is in flurry, he or she may not operate their mobile communication device well and thus lose the chance to call for help.

Nowadays more and more parents give their children mobile phones for commanding where their children are. Concern of children's safety is the main reason for giving them mobile phones. Therefore, an additional function about safety concern is the most important requirement for mobile phones of children.

### SUMMARY OF THE INVENTION

An object of the present invention is to provide a method of sending urgently messages in a mobile communication device.

The present invention provides a method of urgently sending messages in a mobile communication device. First, setting at least two predetermined keys on the first mobile communication device, and pressing the two keys essentially simultaneously for a predetermined duration. Then the first mobile communication device will acquire a base station identity code and obtain location information of the first mobile communication device according to the base station identity code and a preset correspondence table in the first mobile communication device, and final send a message containing said location information to at least one second mobile communication device. When a user of the predetermined mobile communication device receives the predetermined message, the user can deal properly with the situation through the information of the predetermined messages.

Therefore, the present invention provides a method of sending messages urgently for a mobile communication device, wherein the message further comprises a location data. Through the method disclosed herein enhancing additive function of the mobile communication device, especially suitable to children whose safety are most concerned.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a flow chart of calling for help urgently in a general communication phone;

FIG. 2 is a flow chart of sending message in urgent situation;

FIG. 3 is a schematic diagram of a mobile communication device in accordance with a preferred embodiment of this invention;

FIG. 4 is a flow chart of the method in accordance with the present invent invention;

FIG. 5 shows a checking flow chart of the method disclosed in the present invention;

FIG. 6 shows a mode of updating the predetermined correspondence table within the mobile communication device 31;

FIG. 7 shows another mode of updating the predetermined correspondence table within the mobile communication device 31;

FIG. 8 is a flow chart about editing predetermined messages;

FIG. 9 is a flow char about setting communication numbers for predetermined second mobile communication devices.

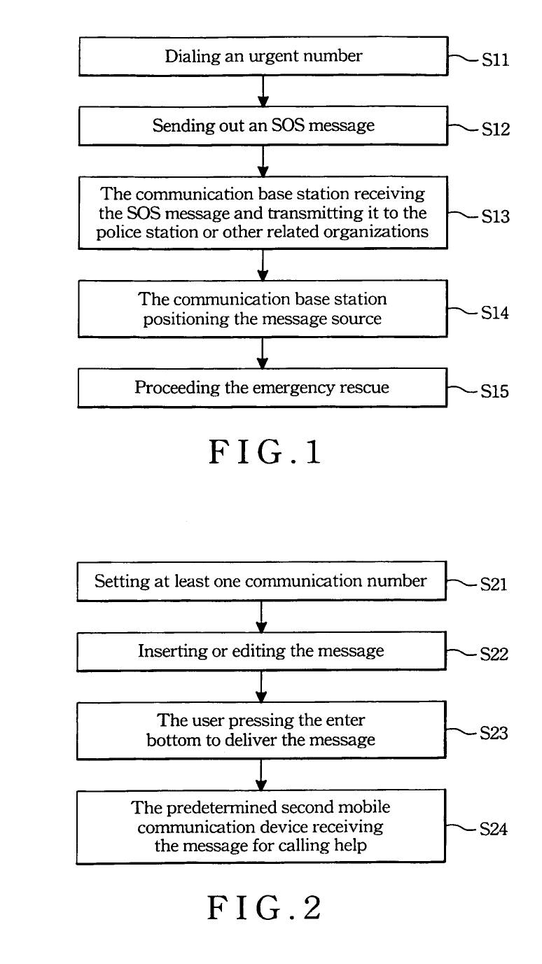

### DETAILED DESCRIPTION OF THE PREFERRED EMBODIMENTS

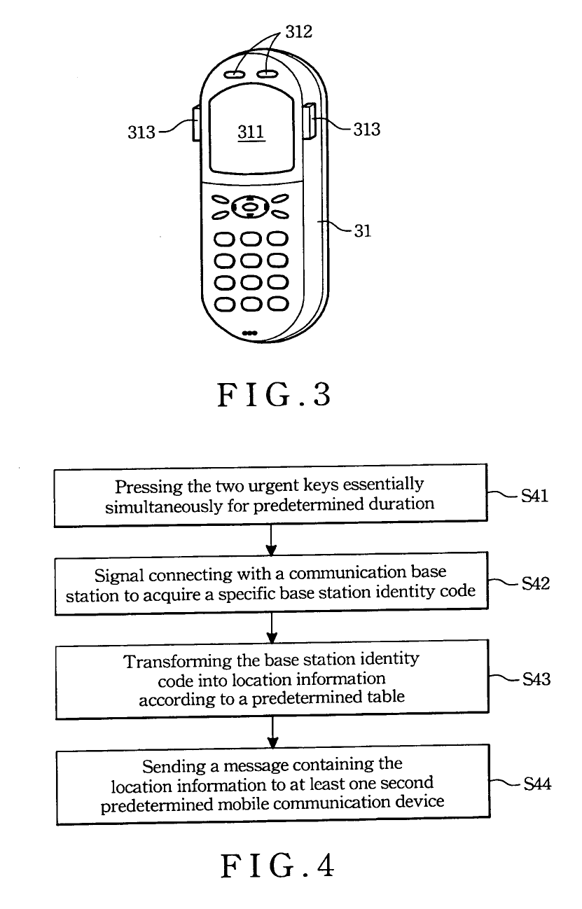

Please refer to FIG. 3, which is a schematic diagram of a mobile communication device in accordance with a preferred embodiment of this invention. The mobile communication device 31 comprises a display unit 311, a hooter 312, and at least two urgent keys 313, wherein the display units is used for displaying and the two keys 313 is disposed on two opposite sides respectively of the mobile communication device 31.

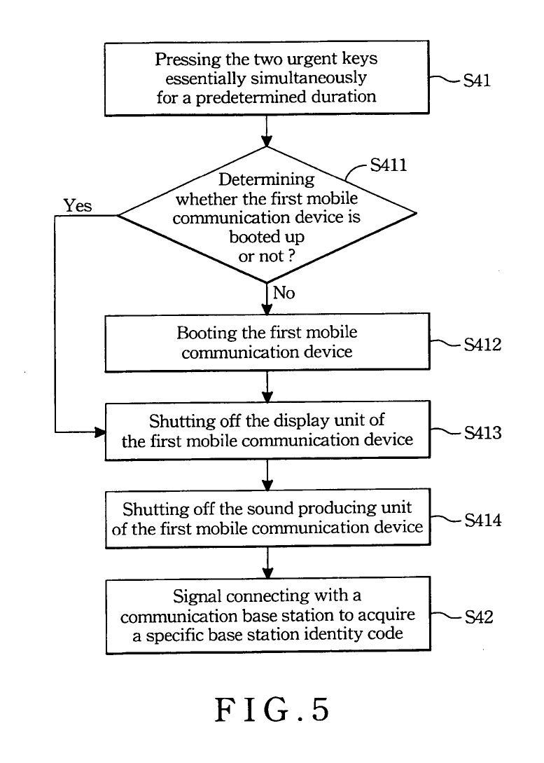

Please refer to FIG. 4, which shows a flow chart of the method in accordance with the present invent invention. Please refer to FIG. 3 and FIG. 4 simultaneously while reviewing the following steps.
Step41 (S41): pressing the two urgent keys 313 essentially simultaneously for predetermined duration, as shown in FIG. 3, wherein two urgent keys 313 are disposed on the opposite sides of the first mobile communication device 31 respectively, and nowadays most mobile communication devices are palm size, hence the user could press two keys simultaneously easily only by one hand; moreover, the two keys may be easy to press in ordinary uses, hence a predetermined duration is set to avoid unexpected pressing, herein the predetermined duration is three seconds, and the user may set the duration on his own;
Step42 (S42): signal connecting with a communication base station to acquire a specific base station identity code. Any mobile communication device and communication base station have specific identity codes there between. A mobile communication device will choose a specific communication base station for signal connecting according to the intensity of electromagnetic wave. Generally, the intensity of electromagnetic wave is directly proportional to the distance between the mobile communication device and the communication base station, and the shorter the distance is, higher the intensity is.
Step43 (S43): transforming the base station identity code into location information according to a predetermined table which records the corresponding relation between the base station identity code and the specific location information. The location information records the location of the first mobile communication device. For instance, if the first mobile communication device is located on Nanjing E. Rd., Jhongshan District, Taipei City; the mobile communication device will obtain the specific location information according to the predetermined correspondence table;
Step44 (S44): sending a message containing the location information to at least one second predetermined mobile communication device, wherein the content of the message can be edited in advance as “HELP!!! In danger in ###”, herein the symbol## is set as location, hence while the message is sending to at least one second predetermined mobile communication device, the content would be “HELP!!! in danger in Nanjing E. Rd., Jhongshan District, Taipei City ”; the user of the first mobile communication device could set several communication numbers for several predetermined second mobile communication devices, after the user of the predetermined second mobile communication device receives the message, they could take next actions. In some urgent situations, for instance, an abducting case, the sound of the hooter or the light of the display unit may let the kidnapper find the motivation of calling for help and then the chance for calling help will be lost. In some situations, the first mobile communication device may be in shunt off status, and the same the chance for calling for help will be lost. Please refer to FIG. 5, which shows a checking flow chart of the method disclosed in the present invention. The method shown in FIG. 5 comprises the following steps.
Step41 (S41): pressing the two urgent keys essentially simultaneously for a predetermined duration;
Step411 (S411): in the mean time determining whether the first mobile communication device is booted up or not, if no, continue with step 412, if yes, jump to step 413;
Step412 (S412): booting the first mobile communication device;
Step413 (S413): shutting off the display unit of the first mobile communication device;
Step414 (S414): shutting off the sound producing unit of the first mobile communication device.

After the checking procedure, the procedure mentioned in FIG. 4 will go on, form step414 to step42, and the order of step413 and 414 may be exchanged.

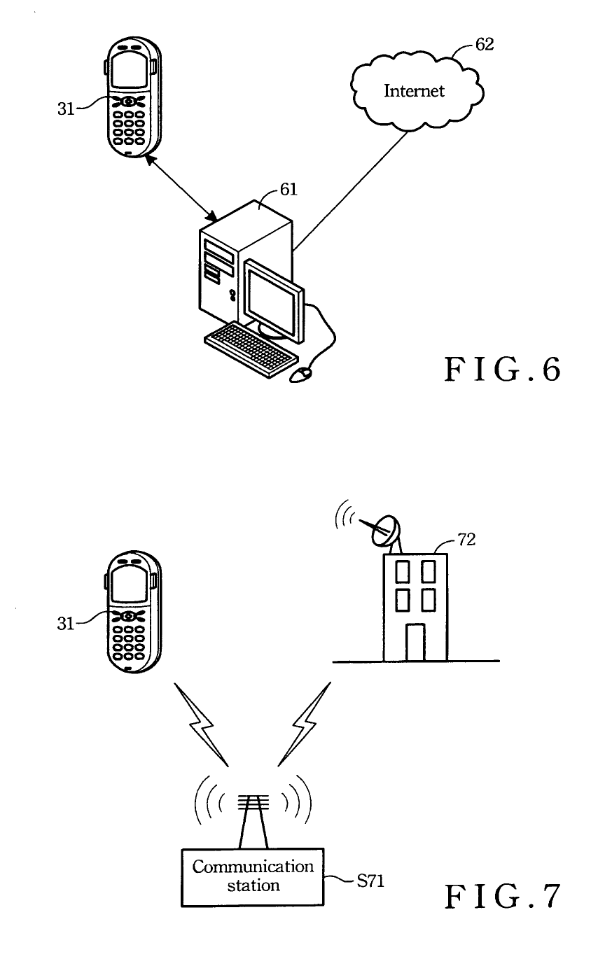

When a communication base station is set up or removed, a updating of the predetermined correspondence table is necessary. Please refer to FIG. 6 and FIG. 7, which show two different modes of updating the predetermined correspondence table within the first mobile communication device 31. As FIG. 6 shows, the first mobile communication device may couple to a computer 61 through wired connection or wireless connection and update the predetermined correspondence table by downloading data from an internet 62 through the computer 61. The mobile communication device 31 also can update the predetermined correspondence table through a communication base station. As FIG. 7 shows, the first mobile communication device 31 could update the predetermined correspondence table form a telecommunication services provider 71 by connecting to the communication base station 71.

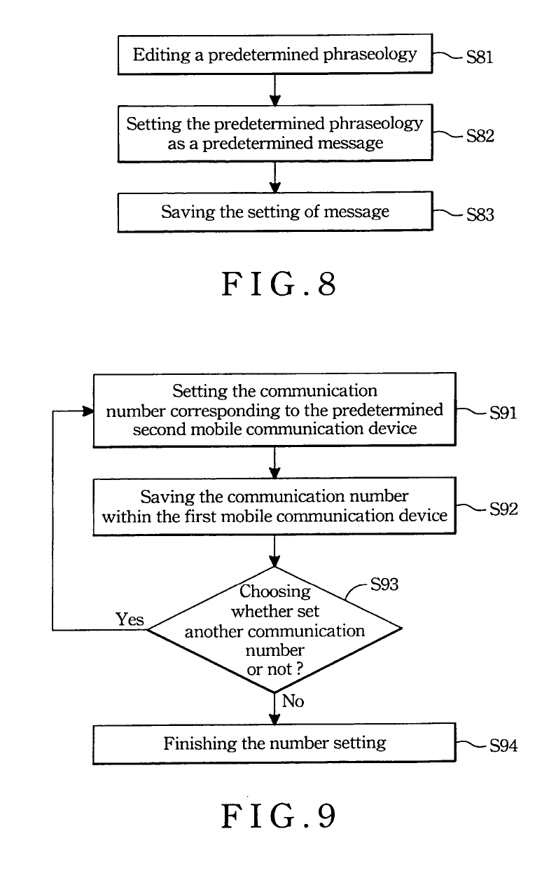

Please refer to FIG. 8, which is a flow chart about editing a predetermined message. First, the user may edit a predetermined phraseology (Step81, S81), then set the predetermined phraseology as a predetermined message (Step82, S82), and finally save the setting of message (Step83, S83).

Please refer to FIG. 9, which is a flow char about setting communication numbers for the predetermined second mobile communication device. First, the user may set the communication number corresponding to the predetermined second mobile communication device (Step91, S91), second, save the communication number within the first mobile communication device(Step92, S92) and then the user can choose whether set another communication number or not (Step93, S93), if yes, return to step91, if no, finish the number setting (Step94, S94).

To summarize, the present invention provides a method for sending urgent messages in a first mobile communication device, wherein the message further comprises location information. Through the method disclosed herein enhancing additional function of the mobile communication device especially is suitable to children whose safety is mostly concerned.

While the present invention has been particularly shown and described with reference to a preferred embodiment, it will be understood by those skilled in the art that various changes in form and detail may be without departing from the spirit and scope of the present invention.

What is claimed is:

1. A method for sending urgent messages in a first mobile communication device comprising the following steps:
pressing at least two keys on the first mobile communication device essentially simultaneously for a predetermined duration;
acquiring a base station identity code by use of the first mobile communication device;
obtaining location information of the first mobile communication device according to the base station identity code and a preset correspondence table in the first mobile communication device; and
sending a message containing said location information to at least one second mobile communication device.

2. The method of claim 1, wherein the predetermined duration is three seconds.

3. The method of claim 1, further comprising the following steps after pressing said at least two keys essentially simultaneously for the predetermined duration:
determining whether the first mobile communication device is booted up;
shutting off a display unit and a sound producing unit of the first mobile communication device if the first mobile communication device is booted up; and
booting the first mobile communication device if the first mobile communication device is not booted up.

4. The method of claim 1, wherein the preset correspondence table contains a mapping between the base station identity code and the location information.

5. The method of claim 1, further comprising updating the preset correspondence table by a telecommunication services provider.

6. The method of claim 1, further comprising updating the preset correspondence table through an internet.

7. The method of claim 1, wherein said at least two keys are sited on two sides of the first mobile communication device.

8. The method of claim 1, wherein the message is predetermined by a user.

9. The method of claim 1, further comprising presetting a communication number for the second mobile communication device.
